(19) United States
(12) Patent Application Publication
(10) Pub. No.: US 2012/0235528 A1
(43) Pub. Date: Sep. 20, 2012

(54) Toroidal inductance generator

(76) Inventor: Michael Robert Axford, Windsor (CA)

(21) Appl. No.: 13/064,317

(22) Filed: Mar. 18, 2011

(51) Int. Cl. H02K 21/00; H01F 7/02

(52) U.S. Cl. 310/152; 335/219

(57) ABSTRACT

The Toroidal Inductance Generator is a machine that creates electrical energy by orbiting three fields of multiple magnets inside and around, a copper wire toroidal coil. The toroidal generator is comprised of a copper wire wound toroidal coil, with a vessel core, containing a plurality of free moving rare earth magnets sealed inside the vessel core assembly. A magnetic shroud is affixed to the protruding shaft of an existing rotary means. This magnetic shroud and rotary means are concentrically positioned to rotate a plurality of magnets immediately adjacent to both the outside and the inside diameter of the toroidal coil. The vector fields of the shroud magnets overlap and interact with the vector fields of the magnets sealed inside the copper wire toroidal core. The internal magnets are caused to follow the rotating field from the applied external coercive magnetic force. The three combined orbits all contribute to the generation of electricity within the copper wire toroidal.

The invention I am describing is an electricity generating machine (FIG. 22&23). The machine induces electricity by moving magnets (7&8) around and within a copper wire toroidal coil (1). My invention uses three orbiting magnetic fields to induce electricity in a copper wire toroidal coil (1). Two of the orbiting fields are external and one of the fields is internal. The internal magnetic field is contrived of, a plurality of permanent rare earth magnets (9), sealed inside a hollow toroidal vessel core (3&4). The internal magnets (9) are caused to move by an applied external magnetic force. Said external force is applied by magnets (7&8), housed externally adjacent to the toroidal coil (1) in a rotatable shroud (2). The shroud (2) configures magnets (7&8) concentrically, immediately adjacent to the inner and outer diameters of the copper toroidal coil (1).

The magnetic fields of the shroud mounted magnets (7&8), permeates the walls of the toroidal vessel core (3&4), copper wire windings (1), and air gap, to overlap and interact with the magnetic fields of the internal magnets (9). The exchange of magnetic field energy simultaneously occurs increasing the field dynamics between the internal and external magnetic fields. The shroud (2) is affixed at the hub to a protruding shaft belonging to an existing rotary motor. When the motor is operating, the shroud (2) affixed to the shaft, rotates a plurality of magnets (7&8) immediately adjacent to the perimeters of the copper toroidal coil (1). The result is induced electricity in the copper wire coil (1). The permanent magnets (9) within the toroidal copper coil core (3&4), whose movement is coerced by the external magnetic fields, induce electricity in the surrounding copper wire toroidal (1). The combination of three orbiting magnetic fields inducing current in the copper wire is an effective method of generating electricity.

### History

It was necessary to discover an electrical source great enough to run my electromagnetic piston motor, without putting an additional load on the crankshaft. To solve those energy needs I examined the construction of a common alternator to see if there was any way of increasing its efficiency. My other project uses permanent rare earth magnets and I accidentally discovered a unique method of moving magnets inside a coil using an external magnetic force. After reverse engineering a standard alternator I knew I could combine the technologies and make a generator powerful enough to suit my needs.

I designed my induction generator to have a set of magnets rotating inside the copper coil, as well as two sets outside. This will generate a substantial amount of current. A toroidal by design is a very efficient shape for a coil so I used it. The form used to shape the winding is a low ferrite toroidal vessel. Copper wire is wound as many times around the toroidal vessel as dimensionally feasible. It can use more wire than any alternator by design. The magnets inside the coil are free to rotate inside the vessel but are held equidistant by a brace to avoid bunching up.

All the internal magnets rotate together at equidistance, in alignment with the external magnets. The magnets sealed inside the coil cannot be moved by any external mechanical means, so magnets were seen as a method of facilitating that movement. By natural law, the overlapping of the opposite magnetic fields, and close proximity of the magnetic sources increases the strength of the interacting fields. This creates a greater induction effect than a standard alternator. I have claimed use of the Schulman frequency pulsed through a separate surrounding wire to further increase the inductive effectiveness. Said effectiveness has not been measured or estimated.

### Utility

My invention is an electrical generator machine, capable of providing an abundance of electricity from the orbiting of magnetic fields inside and outside of a copper wire toroidal. The generators will be manufactured in various output strengths and sizes. A home sized unit will be dimensioned to fit into all homes through the door. The generator will be installed by a licensed electrician, after it's positioned in close proximity to the existing electrical panel in your home. The electrician will disconnect you from your existing supplier's grid. Two 12 volt batteries must be fully charged and positioned next to the D/C motor in a place provided within the generator enclosure. The batteries are connected to a low voltage, ammeter switching means. When one of the two batteries gets weak the second fully charged battery is switched on automatically. The weaker battery is then re-charged by regulated current from the generator. The switching means is then wired to a rotary motor. A start button is wired in line between the power and the motor. When the button is depressed the current from one of the 12 volt batteries begins the normal function of the D/C motor.

The operating D/C motor facilitates the rotation of the magnetic shroud around the fixed copper wire toroidal. The coercive force of the surrounding shroud magnets, facilitate the matching rotary motion of the internal toroidal permanent magnets, through the natural magnetic alignment of overlapping opposite polarities.

All three magnetic orbits combine to induce a constant electrical current in the toroidal coil. This toroidal is wired to various voltage regulators to deliver useable regulated current to the panel and battery recharge system.

The automotive version will be sized to fit under the hood, and enable electric vehicles to draw their electricity from the toroidal inductance generator. The automobile will only need the power of one 12 volt battery to run the generator. This will eliminate the need for increased battery capacity.

### Novelty

What makes my invention novel is that I use the rotation of a shaft mounted magnetic shroud means, to apply multiple magnetic forces to the outside of a copper toroidal coil, that resultantly coerces movement from a plurality of permanent rare earth magnets that are sealed inside the copper wire toroidal, generating electricity in the surrounding coil. The external magnetic fields of the shroud magnets permeate through the copper wire, the toroidal vessel, and the air gap to overlap and inter act with the magnetic fields of the permanent magnets sealed inside the toroidal and align them following the natural attraction of overlapping opposite magnetic fields. When the shaft is rotating, the overlapping opposite magnetic fields, induce electric current in the surrounding copper coil. There are three separate orbits of magnetic fields being moved across the copper wire toroidal. Two orbits are external and one orbit is internal.

The novelty is that this is the only invention to use this method of inducing electrical current by rotating permanent magnets inside a closed sealed toroidal coil core using overlapping external magnetic coercive forces to facilitate their movement. This is the only generator to use magnetic field interaction as a drive mechanism to rotate a plurality of permanent magnets sealed inside a copper toroidal coil core. I have no knowledge of any prior art describing any generator device that rotates permanent magnets inside the confines of a toroidal coil core, having their internal rotary movement coerced by the application of external magnetic fields.

### SUMMARY

The Toroidal Inductance Generator was invented by Michael Robert Axford in Windsor Ontario Canada on Jan. 1, 2009.

The generator was invented from the necessity to discover an abundant electrical source to run my electromagnetic piston motor invention, without adding load to the crankshaft. I used some knowledge gleaned from research into alternators, as well as past experience with electrics and magnetism.

The Toroidal Inductance Generator is a machine that creates electrical energy by orbiting three fields of multiple magnets inside and around, a copper wire toroidal coil. A magnetic shroud is rotated by being affixed to an existing rotary means. The shroud is a housing means for a plurality of magnets to be affixed to its inward facing surfaces. The magnets are fixed within the shroud, and are configured to be maintained at a minimum equidistance from the peripheries of the toroidal coil.

The proximity of the shroud, to the permanent magnets sealed inside the toroidal core, causes the vector fields of all the magnets, to overlap and interact. The rotator means is activated. The magnets in the shroud begin to orbit the toroidal coil.

The permanent magnets inside the toroidal core are caused to move following the external coercive magnetic force emitting from the opposite poles of the magnets rotating with the shroud. The rotating fields, two external and one internal, combine to induce electricity in the copper wire coil.

### PARTS

### Part 1

The first part I am describing is a copper wire wound toroidal (1). The copper wire is wound around a pre formed toroidal vessel core (3&4). The windings follow the contours of the toroidal. The entire circumference of the toroidal vessel core (3&4) is circled with copper wire. The wire is wound tightly and neatly adjacent, around the toroidal vessel core (3&4) to maximize the number of turns per layer. The wire continues being wound beyond 360 degrees of windings and subsequent layers of windings are continually added to the perimeter of the vessel (3&4) until the toroidal coil (1) reaches its desired dimensions and number of turns. The coil (1) is insulated to prevent arcing. The coil (1) has one additional single layer of insulated copper wire which is wrapped outside the insulation.

### Part 2

The second part I am describing is a shaft mounted shroud (2). This part consists of a hub portion, a radial flange, and an outer ring portion. The hub portion of the shroud (2) is designed to fit over the protruding shaft of an existing rotary motor means. A keyway provides alignment and a standard set screw affixes the shroud hub to the protruding motor shaft. They will now rotate as one.

The shaft hub consists of an inner diameter and an outer diameter. The inner diameter is dimensioned to be fully occupied by the motor shaft it connects to. The outer diameter of the hub portion is contoured with a plurality of pockets, recessed into the perimeter face of the hub portion, parallel with the motor shaft. These pockets are dimensioned to allow permanent rare earth magnets (7,&8) to be affixed within said pockets. The depth of the pocket recess is measured to allow one half of said magnets (7&8) to protrude beyond the outside diameter face of the hub portion.

The flange portion radiates from the hub portion 360 degrees at right angles to the axis at one end of the hub portion. Its outer radial diameter is greater than the diameter of the toroidal coil (1,) it is to enshroud. The flange portion is gusseted to the hub portion.

The outer ring portion extends parallel to the shaft outward from the flange face at its outer diameter to a distance equal to that of the hub portion. The outer ring, the flange, and the hub, configure a three 3 sided circular shroud. The outer ring is contoured to have pockets recessed into the inner face of the outer ring, parallel to the hub pockets, to accommodate the fitting of magnets (7&8) into said pockets. The pockets in the outer ring will be configured to be exactly aligned with the pockets on the hub. The outer ring is gusseted to the flange.

### Part 3

The third part I am describing is one half of a low ferrite toroidal vessel (3) separate from its mating half, (4) mid plane across the axis. The half toroidal is shelled inward to have an inner surface contour matching the outer surface contour at a thickness sufficient to hold its shape and accommodate sealant grooves between the inner toroidal walls and the outer toroidal walls and sufficient wall stock to accommodate fastening holes to mate the two halves of the assembly. This half of the toroidal vessel is designed to have a sealable access port to add lubricant to the vessel void after it has been mated with its component part (4). The access port is sealed before the toroidal is wrapped with copper wire (I).

### Part 4

The fourth part I am describing is a low ferrite toroidal half (4) separate from its mating half (3) mid plane across the axis. The half toroidal (4) is shelled inward to have an inner wall contour matching the outer wall contour and have a wall thickness sufficient to hold its shape. This half of the toroidal has contours to accommodate fastening holes so it can facilitate mating to its counterpart. (3).

### Part 5

The fifth part I am describing is a spacer brace (5) for affixing equidistant spherical capsules (6) to its contours. The spacer brace is made of a low ferrite material that will not compromise its characteristics when submerged in lubricant indefinitely. The spacer brace is designed to affix a plurality of spherical capsules (6) at equidistance on a single plane through 360 degrees.

### Part 6

The sixth part I am describing is a two piece spherical capsule (6). This capsule is contrived of two identical halves shelled inwardly and has a wall thickness sufficient to hold its shape. The inner contours of the capsule are designed to nest a cylinder shaped permanent magnet (9). Each half of the sphere is exactly 180 degrees. One half of the magnet (9) is nested into each half of the sphere (6) respectively. The nested magnet (9) transfers its polarity to the adjacent ferrite sphere (6) causing it to be held magnetically to the spheres (6) and magnetically charged by the natural laws of magnetic transference.

The sphere (6) is made of a high ferrite material that will not compromise its characteristics when submerged in lubricant indefinitely. The seam of the two spherical halves (6) is contoured in a manner that allows the spheres to be affixed to the spacer brace (5).

### Part 7

The seventh part I am describing is a manufactured magnet. Part 7 can is designed to flexible as to its magnetic properties. It is made to be a permanent rare earth magnet, or an electromagnet, or both. Part 7 is attached to the hub face of the shroud (2), fitting into the recessed pockets provided by the design.

### Part 8

The eighth part I am describing is a manufactured part. Part 8 is designed to be flexible in its magnetic properties. Part 8 is made to be a permanent rare earth magnet or an electromagnet, or both.

### Part 9

The ninth part I am describing is a standard manufactured cylindrical neodymium permanent rare earth magnet (9). This magnet is sized appropriately to fit entirely within the spherical capsules (6).

### Part 10

The tenth part I am describing is a standard manufactured socket head cap screw.

### Part 11

The eleventh part I am describing is a standard nut fastener, sized to mate with part 10.

### DRAWINGS

FIG. 1) Front view of the copper wire toroidal coil. (1)

FIG. 2) Side view of the copper wire toroidal coil. (1)

FIG. 3) Isometric view of the copper wire toroidal coil. (1)

FIG. 4) Front view of the shroud

FIG. 5) Top view of the shroud

FIG. 6) Isometric view of the shroud

FIG. 7) Top view of the filler half of the toroidal core (3)

FIG. 8) Side view of the filler half of the toroidal core (3)

FIG. 9) Bottom view of the filler half of the toroidal core.

FIG. 10) Isometric view of filler half of toroidal core (3)

FIG. 11) Top view of the mating part of the toroidal core (4)

FIG. 12) Side view of the mating half of the toroidal core. (4)

FIG. 13) Bottom view of the mating half of the toroidal core (4)

FIG. 14) Isometric view of the mating half of the toroidal core (4)

FIG. 15) Front view of a spacer brace (5)

FIG. 16) Side view of a spacer brace (5)

FIG. 17) Isometric view of a spacer brace (5)

FIG. 18) Bottom view of one half of the spherical capsule (6)

FIG. 19) Side view of spherical capsule (6)

FIG. 20) Isometric view of the spherical capsule (6)

FIG. 21) Toroidal core assembly (3,4,5,6)

FIG. 22) Isometric view of toroidal vessel core

FIG. 23) Front view of Toroidal Inductance Generator assembly. Part 4 is suppressed (1,2,3,5,6,7,8)

FIG. 24) Isometric view of Toroidal Inductance Generator assembly Part 4 is suppressed (1,2,3,5,6,7,8)

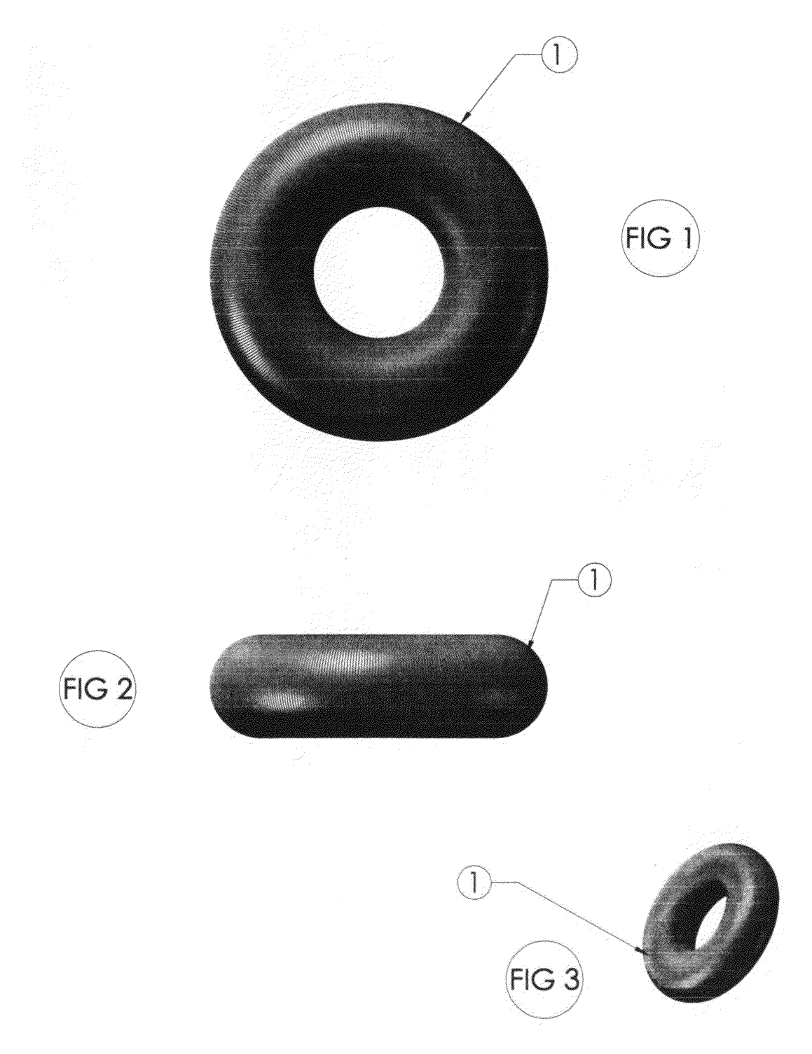

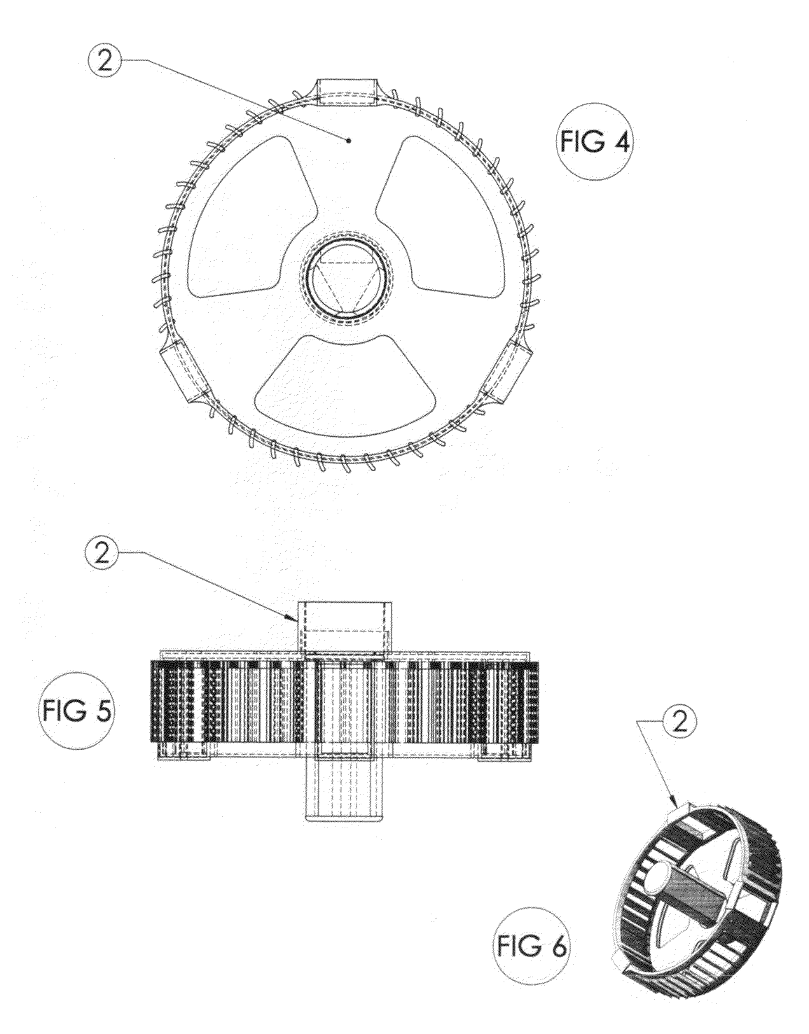

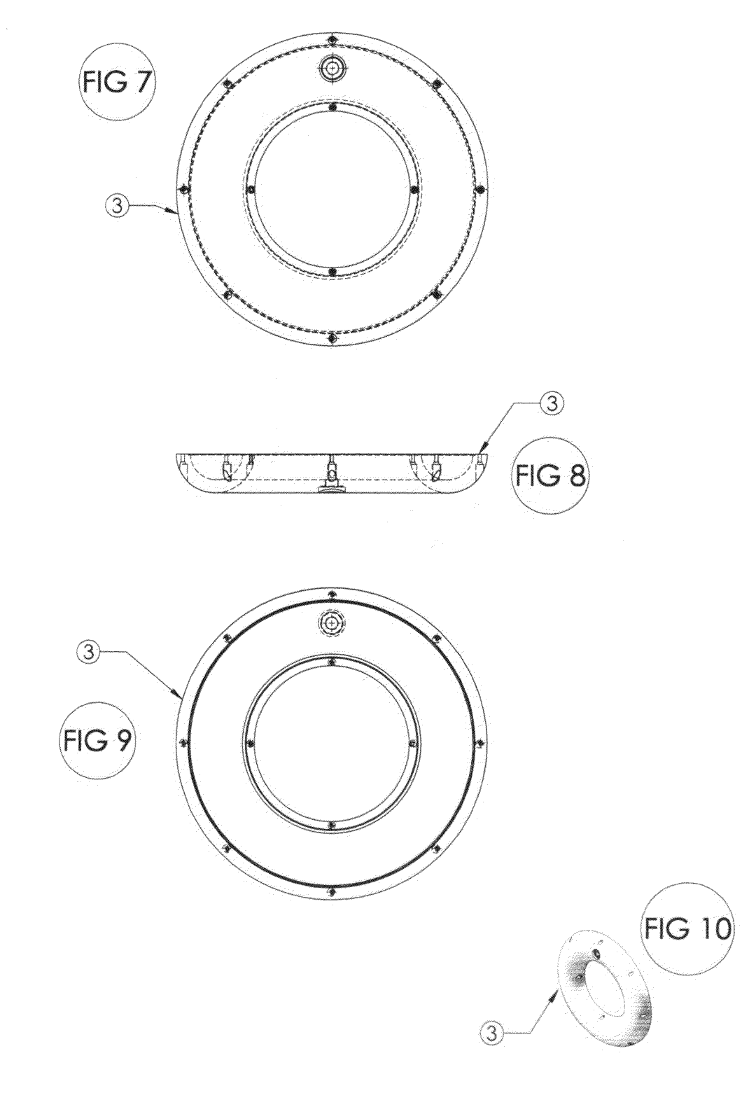

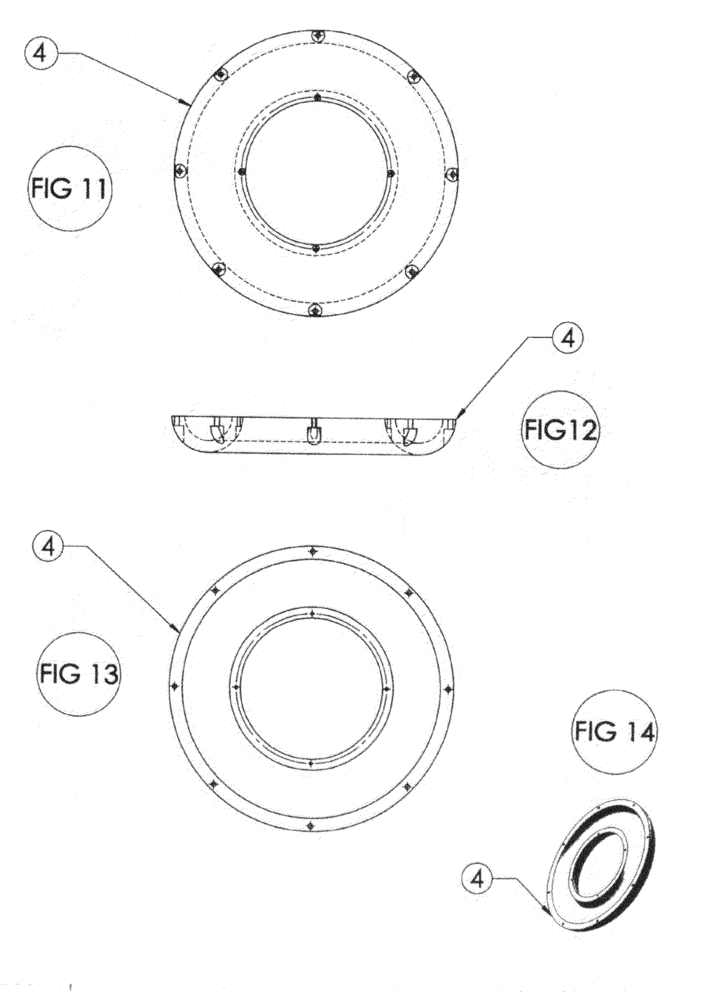

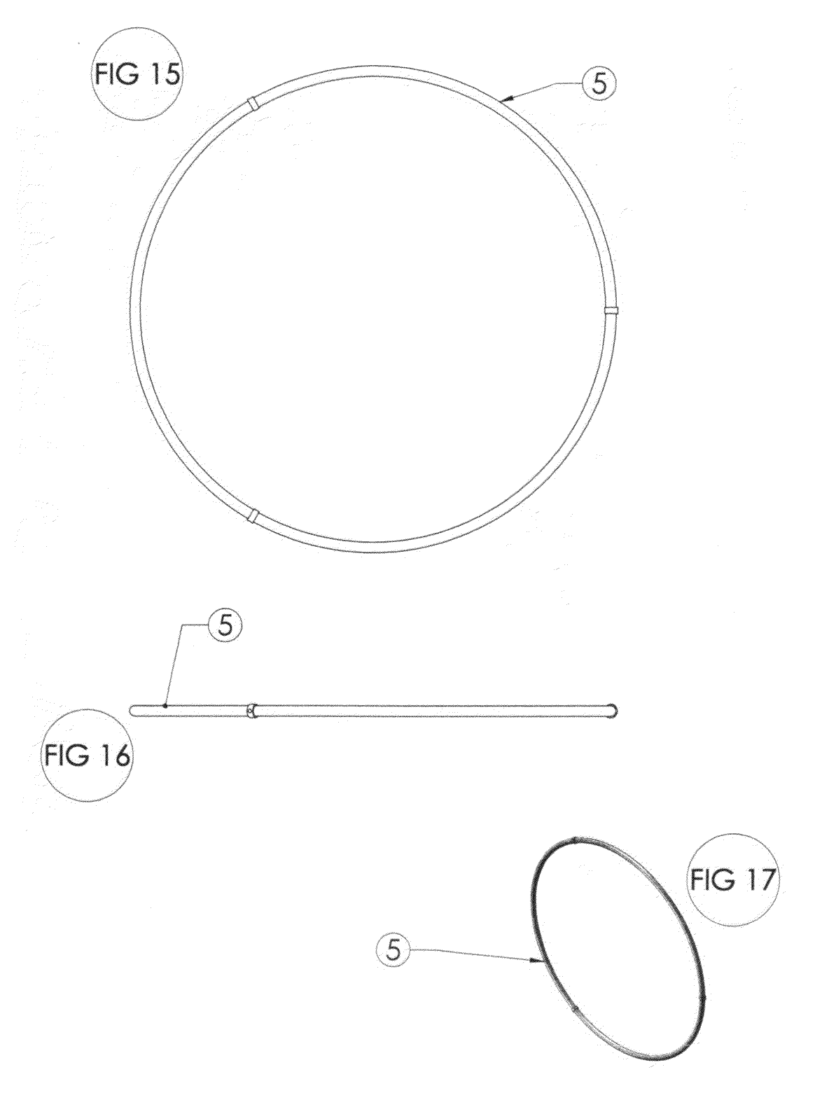

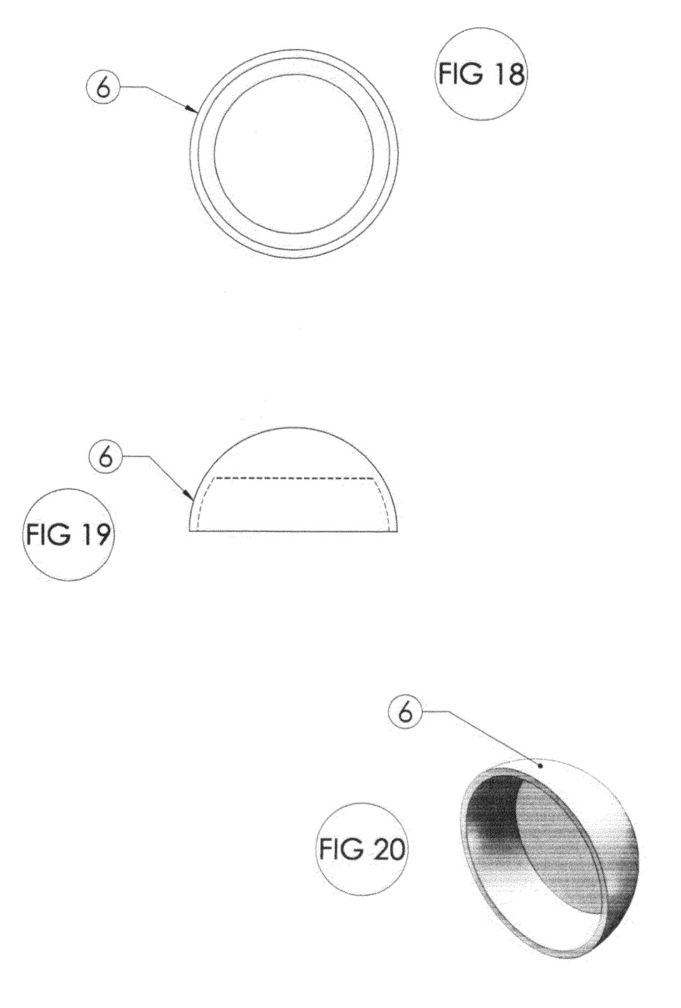

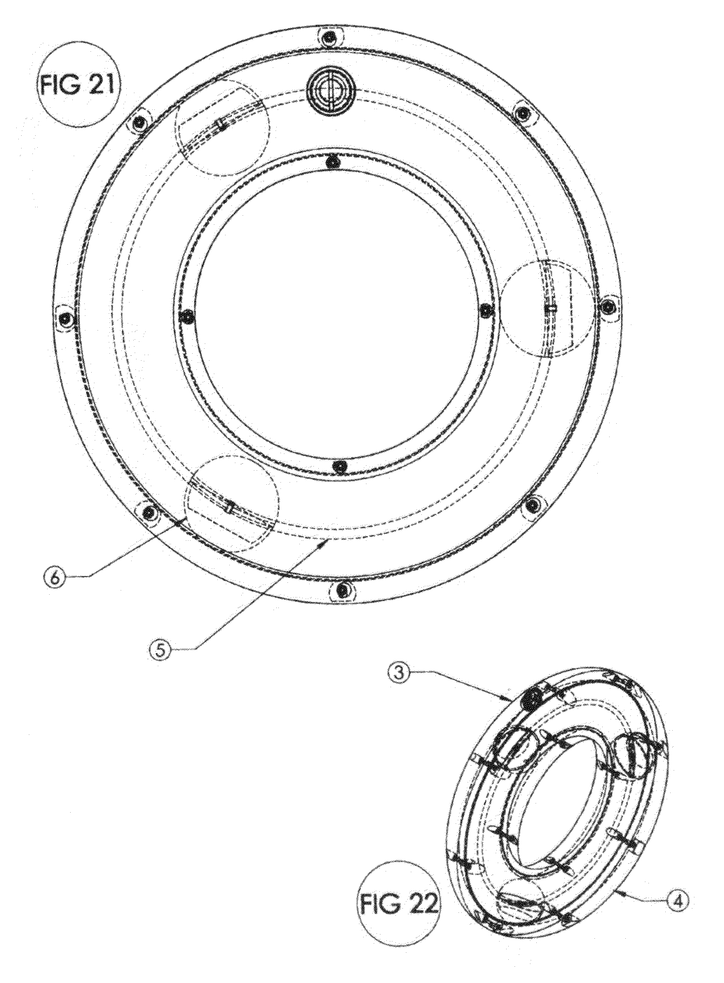

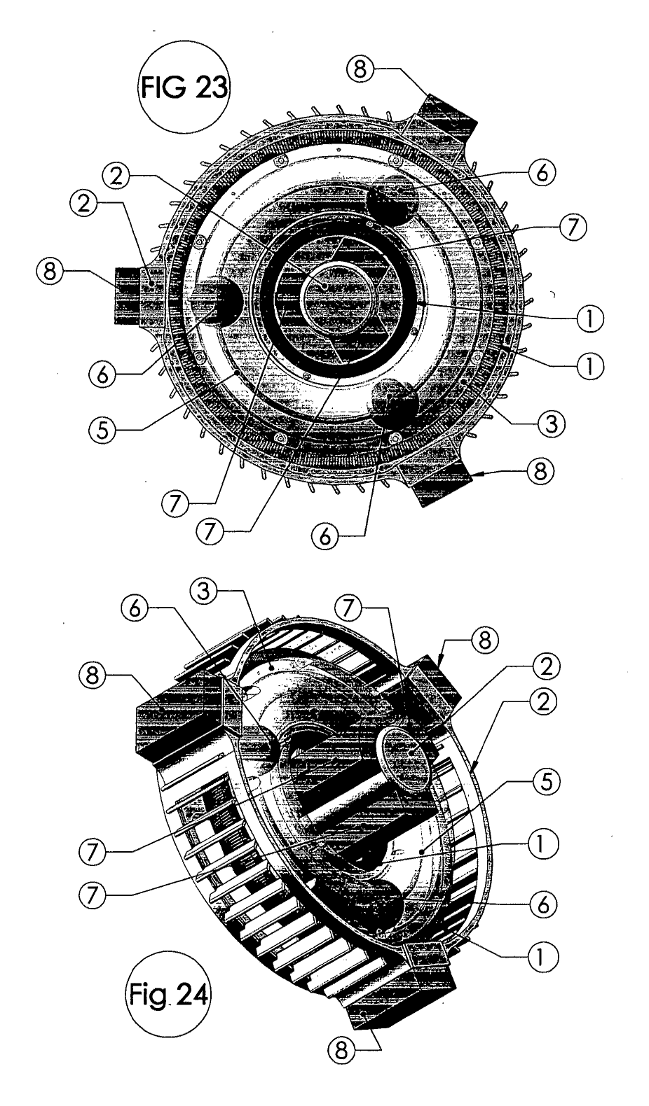

1. The first claim I am making is for the invention called the Toroidal Inductance Generator.
I claim as my invention an electrical generator machine: The invention I am claiming is contrived of a shaft mounted magnetic shroud device, which when rotating, is capable of inducing electrical current, in a fixed adjacent copper wire wound toroidal coil by rotating a plurality of equidistant magnets, both inside, and outside, a two piece, sealed, circular, low ferrite, copper wire wound, toroidal vessel core. This vessel core assembly is wrapped in copper wire, encircling its circumference, radial from the axis.
The machine consists of two main assemblies that are affixed adjacent to each other. The first assembly being a low ferrite toroidal vessel wrapped with copper wire containing a plurality of free moving permanent rare earth magnets sealed inside.
The second assembly is a shaft mounted magnetic shroud containing a plurality of magnets on the hub portion of the shroud and on the inside face portion of the outer ring portion of the shroud, which when positioned correctly, relative to the toroidal coil, will shroud the toroidal on three sides. This will configure a plurality of magnets to be positioned directly adjacent to the toroidal coil on the outside diameter and adjacent on the inside diameter of the toroidal.
The magnetic fields of the shroud envelop the outside perimeter and the inside diameter of the copper coil simultaneously. The said magnetic fields overlap and interact with the toroidal coil's internal magnets. The opposing polarities of the internal magnets become aligned with the opposing polarities of the surrounding fields of the shroud. The internal magnets are held in this aligned position with coercive magnetic force.
A standard rotary motor with a protruding shaft is necessary equipment for the function of this invention. The claimed magnetic shroud is affixed to said protruding shaft of an existing rotary motor.
The shaft of said motor is normally rotated on axis, facilitating the rotation of the magnetic shroud around the adjacent surfaces the fixed toroidal vessel.
The coercive force of the overlapping magnetic fields facilitates the rotation of the permanent rare earth magnets inside the toroidal vessel. The internal magnets are caused to rotate by the application of an external magnetic force. The three combined orbiting magnetic fields of the magnets, one inside the toroidal coil and two outside the toroidal coil induce electric current in the copper wire surrounding the vessel.
The shroud and the toroidal generator coil, never contact each other. The toroidal generator uses the invisible magnetic fields of the shroud magnets to coerce movement from the magnets inside the toroidal vessel, resultantly inducing electrical current in the surrounding copper wire. I claim this device as my intellectual property.

2. The second claim I am making is for a low ferrite, liquid impervious, toroidal vessel. This toroidal vessel will be contrived of two or more pieces, and when assembled will create a closed, air tight, hollow toroidal. The hollow chamber, being the inside void of the toroidal, will be partially filled with a highly viscous liquid lubricant, and will be sealed air tight to prevent the liquid lubricant from leaking out. The hollow inner area of the toroidal is smooth, and guides the permanent magnets that revolve within the vessel. The toroidal is the housing means for the internal magnets. These internal magnets, and the circular brace connecting them, are allowed to revolve freely as an assembly, within the lubricant, and the confines of the sealed toroidal. The toroidal is made from a material that will not compromise its characteristics when containing lubricant indefinitely.

3. The third claim I am making is for an induction generator coil that is wrapped around a hollow vessel core, with a plurality of permanent magnets inside. The generator ring is contrived of a toroidal vessel as described in claim 1. The toroidal is wrapped with copper wire circling its circumference, radial from the axis. The copper wire is wound neatly allowing minimal distance between turns, and layered as many times as dimensions will permit. The more turns of copper wire the coil is comprised of, the more current that can be induced. The copper wire is wrapped around the toroidal, in a way to maximize that effect. There is a plurality of free moving permanent rare earth magnets, inside the toroidal vessel the copper wire is circled around. The internal magnets rotation is caused by the application of an external magnetic force.

4. The fourth claim I am making is, for the method of inducing current by rotating on axis, a plurality of permanent magnets, inside a copper wire wound toroidal vessel (part 3 and 4), using an applied external coercive magnetic field, emitting from magnets affixed to a shroud (part 2), for the purpose of coercing rotation of said internal magnets, and inducing current from orbiting magnetic fields both inside and outside the surrounding copper coil.

5. The fifth claim I am making is for a spacer brace. This brace is circular, and rigid, and is used as a means of affixing a plurality of spherical capsules equidistant through 360 degrees on a single plain. The spherical capsules are affixed to the circular brace purposely to direct the field emissions of common polarities, in any direction deemed effective for maximizing the inductance of electricity in the surrounding coil. The brace is made of low ferrite materials that will not compromise their characteristics while submerged in lubricant indefinitely.

6. The sixth claim I am making is for a two piece, spherical capsule. These spheres will be halved, each half being contrived of 180 degrees of the sphere. Each half is shelled inward to create a void. This void will be contoured to nest a permanent magnet, entirely within the void of the spherical capsule. The void will be contoured to accommodate any shape magnet and transfer one polarity of its magnetic field effect, onto the ferrous composition of the first half sphere to cause that half of the ferrite sphere to become predictably magnetic.
The first half of the sphere would be affixed to the north pole of the magnet. The second 180 degree half of the sphere, would be affixed to the south pole of the magnet. This assembly creates one 360 degree sphere with magnetically opposed halves. This allows any shape magnet to be converted for use, as a spherical magnet in the invention described in claim 1. The composition of the magnetic material of which the sphere is contrived, must be capable of with standing the effects of submersion in lubricant indefinitely with out compromising its characteristics.

7. The seventh claim I am making is for the orbiting of multiple magnetic fields, both internally and externally around a copper wire wound toroidal vessel to induce electricity. This is the first time a plurality of magnets has been rotated both inside the winds of copper toroidal coil, and outside the winds of the toroidal coil simultaneously, to induce electricity. My invention uses the natural laws of opposing magnetic forces, and applies an external magnetic force to permeate the walls of the toroidal vessel, the copper wire coil and air gap to cause movement to the internal magnets of the toroidal vessel. The close proximity of the opposing fields amplifies the normal coercive strength of the individual magnetic fields, causing an increased field strength, and inductance efficiency.

8. The eighth claim I am making is for the use a 360 degree copper wire wound toroidal coil, in a generator device described in claim 1.

9. The ninth claim I am making is for the use of a low ferrite toroidal vessel core, as containment means, for a plurality of permanent magnets to be rotated or held fixed within its void.

10. The tenth claim I am making is for a shroud device necessary for the function of the generator described in claim 1. This attachment is mechanically affixed to the existing motor shaft as described in claim 1. This attachment is contrived of a hub portion, a flange portion and an outer ring portion. The shroud is dimensioned and contoured to fit around the contours of a toroidal, so that is shrouds the toroidal on three sides. There are pocket recesses in the outer diameter face of the hub and facing inner diameter surface of the outer ring. The recess contours are positioned to be exactly opposite, across the gap between the hub and outer ring. The recesses are fitted with magnets. The shroud is made from low ferrite material.

11. The eleventh claim I am making is for a power boost application to the generator described in claim 1. A separate copper wire is wound around the existing copper coil toroidal described in claim 1. The ends of this wire are connected to a separate frequency generator means. Using a separate power source, electrical circuit, and a frequency generator means, the Schulman frequency or a ten times multiple of the Schulman frequency, is pulsed through said wire while the generator is operating, to increase the effectiveness of the generator. I am claiming the use of this application of science to my invention as my intellectual property.

12. The twelfth claim I am making is for an alternating current type of the inductance generator that is identical to the invention described in claim 1 but has fixed internal magnets. The difference being the internal magnets described in claim 1, rotate inside the toroidal vessel. In claim 12 the internal magnets are fixed. Said magnets are held equidistant by a brace described in claim 5. I claim this brace as my intellectual property.

13. The thirteenth claim I am making is for a machine similar to the invention described in claim 1. I am claiming use of this technology know as the toroidal inductance generator in a pluralized application of the same science. Whether the pluralizing is axial or radial, or in number, I claim all multiple configurations of my invention as my intellectual property.

14. The fourteenth claim I am making is for an invention exactly like that described in claim 1, which uses thermal energy properties to as a method of causing rotation in an effective turbine rotor, to facilitate the necessary rotation of the magnetic shroud, ultimately inducing electricity in the coil. This alternative drive method of the toroidal inductance generator I claim as my intellectual property.

15. The fifteenth claim I am making is for an invention exactly as described in claim 1 that derives its means of rotating the magnetic shroud, by any external means capable of causing such action.

16. The sixteenth claim I am making is for a toroidal coil for use in the invention described in claim 1 that is wound in a Ferrite Honeycomb style, formed to follow the contours of the toroidal vessel core.

17. The seventeenth claim I am making is for an invention exactly as described in claim 1 that has a similar toroidal coil, as claimed, and is comprised of an electrically conductive material other than copper.

18. The eighteenth claim I am making is for a machine exactly as described in claim 1 that uses the claimed machine in a reverse method, and rotates the toroidal coil around a fixed shroud.
